(19) United States
(12) Patent Application Publication
(10) Pub. No.: US 2026/0217289 A1
(43) Pub. Date: Jul. 30, 2026

(54) RAIL-GUIDED CARRIER SYSTEM

(71) Applicant: Murata Machinery, Ltd., Kyoto-shi, Kyoto (JP)

(72) Inventor: Makoto Kobayashi, Kyoto-shi, Kyoto (JP)

(73) Assignee: Murata Machinery, Ltd., Kyoto-shi, Kyoto (JP)

(21) Appl. No.: 19/145,731

(22) PCT Filed: Oct. 26, 2023
(86) PCT No.: PCT/JP2023/038752

§ 371 Date: Jul. 3, 2025

(30) Foreign Application Priority Data
Jan. 11, 2023 (JP) 2023-002623

(51) Int. Cl. B61J 1/10; B61B 3/02

(52) U.S. Cl. CPC B61J 1/10; B61B 3/02

(57) ABSTRACT

In a rail-guided carrier system, a working position at which a processing device performs work on a rail-guided carrier stopped on a track is set. The rail-guided carrier system includes a retraction mechanism configured to retract a part of the track facing a work target portion of the rail-guided carrier at the working position.

### CROSS REFERENCE TO RELATED APPLICATIONS

This application is a US national stage filing under 35 U.S.C. § 371 of International Application No. PCT/JP2023/038752, filed Oct. 26, 2023, which claims priority to Japanese Patent Application No. 2023-002623, filed Jan. 11, 2023, each of which is incorporated herein by reference in its entirety.

### TECHNICAL FIELD

This disclosure relates to a rail-guided carrier system.

### BACKGROUND

There is known a system in which traveling vehicles each travel on a traveling track including a main body housing a traveling unit of the traveling vehicle and extending along a traveling route, and power feeders provided along the extending direction of the main body and supplying electricity to the traveling unit (for example, WO 2020/202856). In the system described in WO 2020/202856, a working track for performing maintenance on the traveling vehicle is provided. The working track is not provided with such power feeders and top surface portion that are provided in the traveling track, and an opening that exposes a part of the traveling unit is formed. Maintenance work (cleaning work or the like) of the traveling vehicle is performed through the opening. Since the traveling vehicle cannot be self-propelled on the working track, the traveling vehicle is moved to the opening by a separately provided moving mechanism.

In the above-described system, the traveling vehicle (rail-guided carrier) is moved to the working track by the moving mechanism, and the work on the rail-guided carrier is performed at the opening. Thus, due to the absence of the power feeders, the absence of the top surface portion, and the like, time required for a process of moving the traveling vehicle to the working track may increase, or the maintenance work itself may be complicated.

This disclosure describes a rail-guided carrier system that can easily perform work on a rail-guided carrier.

### SUMMARY

Disclosed herein is:
A rail-guided carrier system in which a working position at which a processing device performs work on a rail-guided carrier stopped on a track is set, the rail-guided carrier system including a retraction mechanism configured to retract a part of the track facing a work target portion of the rail-guided carrier at the working position.

In this rail-guided carrier system, the part of the track is retracted by the retraction mechanism. Thus, similarly to a traveling track, a track for the working position can also include a configuration necessary for traveling of the rail-guided carrier up to the working position reached by the rail-guided carrier. For example, unlike WO 2020/202856, a configuration in which a power feeder is included in a working track is also possible. Thus, the rail-guided carrier can be self-propelled to the working position. After the part of the track is retracted by the retraction mechanism, the work is performed, by the processing device, on the work target portion of the rail-guided carrier stopped at the working position. That is, the work is allowed only by causing the rail-guided carrier to be self-propelled to the working position and causing the part of the track to move to a retracted position while the rail-guided carrier is stopped at the working position, and the work on the rail-guided carrier can be easily performed.

The retraction mechanism may retract at least a part of a top surface portion of the track, and the processing device may be in contact with an upper portion of the rail-guided carrier from above to measure a position of the upper portion, or may photograph the upper portion of the rail-guided carrier. Thus, the position measurement, the photographing of an image, or the like of the upper portion of the rail-guided carrier can be automated.

The top surface portion of the track may include a plate-like portion extending in a traveling direction of the rail-guided carrier, the rail-guided carrier may include a touch roller for position recognition that comes in contact with the plate-like portion of the track, and the retraction mechanism may retract only a movable portion other than a specific portion with which the touch roller is in contact at the working position, of the plate-like portion facing the upper portion of the rail-guided carrier. Thus, the specific portion with which the touch roller is in contact does not move, and the contact with the touch roller is maintained. Thus, a state in which the rail-guided carrier can recognize its own position is maintained, and return-to-operation after the work can be smoothly performed. This leads to a reduction in cycle time. In addition, since the part of the track that moves is not in contact with the touch roller, that part does not rub against the touch roller by the retraction, and wear of the touch roller is inhibited.

The plate-like portion may be magnetic plates, and the specific portion may be a fixed magnetic plate with which the touch roller is in contact at the working position, and the movable portion may be movable magnetic plates adjacent to a front and a back of the fixed magnetic plate in the traveling direction. Thus, the work can be easily performed in the rail-guided carrier driven by a linear motor. Only the movable magnetic plates may be retracted by the retraction mechanism and after the work, only the movable magnetic plates may be made back to a normal position (advancing position). Thus, the return-to-operation after the work can be smoothly performed.

The work target portion may be exposed by the retraction mechanism sliding and moving the part of the track from the normal position to the retracted position. Thus, access to the work target portion is allowed at a portion of the normal position at which the part of the track is originally located, by the part of the track sliding and moving. Thus, the processing device can be disposed easily in an area that does not hinder the travel of the rail-guided carrier (outside a traveling locus of a traveling unit), and the work can be performed more quickly.

A first moving direction of the part of the track retracted by the retraction mechanism may be orthogonal to a second moving direction in which a working portion of the processing device moves toward the rail-guided carrier for the work. Thus, the work target portion is facilitated to be smoothly exposed. The working portion of the processing device can easily access the work target portion.

The work on the rail-guided carrier is allowed only by moving the part of the track, and the work can be easily performed.

### BRIEF DESCRIPTION OF THE DRAWINGS

FIG. 1 is a schematic plan view illustrating a rail-guided carrier system according to an embodiment.

FIG. 2 is a schematic front view of a rail-guided carrier as viewed from a traveling direction.

FIG. 3 is a perspective view illustrating a traveling unit of the rail-guided carrier.

FIG. 4(a) is a view of a top surface portion of a track at a working position as viewed from below, and FIG. 4(b) is a view illustrating a state in which a part of the track is moved (retracted) from the state of FIG. 4(a) to a retracted position.

FIG. 5(a) is a side sectional view of the track and the rail-guided carrier in the state of FIG. 4(a), and FIG. 5(b) is a side sectional view of the track and the rail-guided carrier in the retracted state of FIG. 4(b).

FIGS. 6(a) and 6(b) are side sectional views illustrating movement of portions in a modification of simultaneous driving type in which a retraction mechanism being a part of a track and a moving mechanism for work are combined.

FIGS. 7(a) and 7(b) are side sectional views following FIGS. 6(a) and 6(b), illustrating the movement of the portions in the modification of simultaneous driving type.

### REFERENCE SIGNS LIST

1 rail-guided carrier system
4 traveling track
6 traveling vehicle (rail-guided carrier)
40D top surface portion
40F magnetic plate
41 working track
54 auxiliary roller
54T upper end (upper portion)
57 power supply core
57T upper surface (upper portion)
59 LDM
59T upper surface (upper portion)
60, 60A retraction mechanism
73 magnetic plate
75 movable magnetic plate
78 fixed magnetic plate
80, 80A processing device
83 sensor contact (working portion)
D1 first moving direction
D2 second moving direction
P1 normal position
P2 retracted position

### DETAILED DESCRIPTION

An embodiment of this disclosure will be described below with reference to the drawings. In the description of the drawings, the same elements are denoted by the same reference signs and an overlapping description is omitted. In some drawings, “up”, “down”, “left”, “right”, “front”, and “back” directions are defined for convenience of explanation.

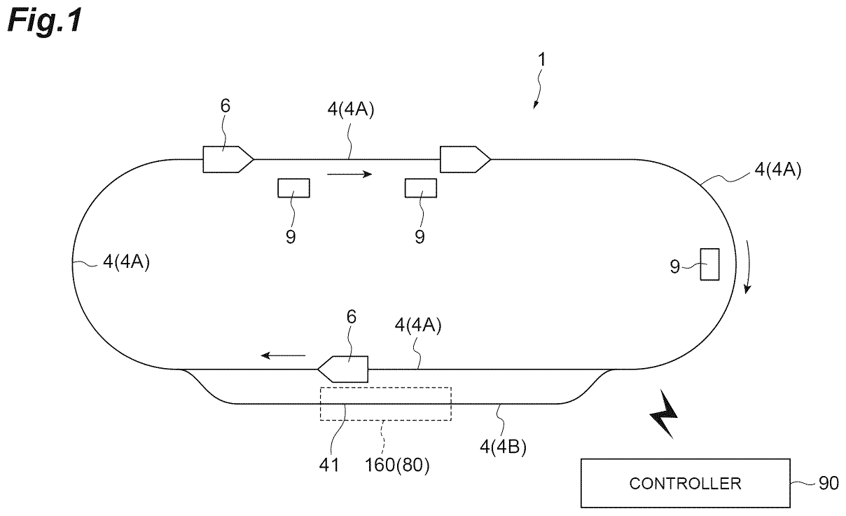

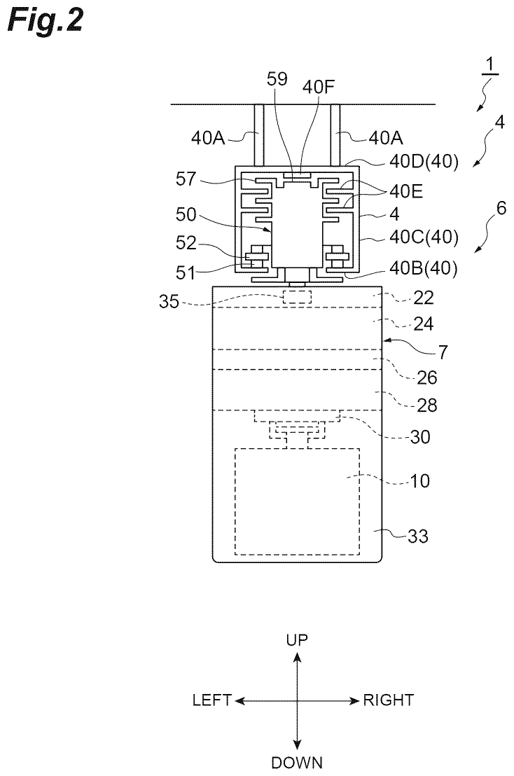

As illustrated in FIGS. 1 and 2, a rail-guided carrier system 1 is a system for transporting an article 10 between placement sections 9 and 9 using an overhead traveling vehicle (rail-guided carrier) 6 movable along a traveling track (track) 4. Examples of the article 10 include containers such as a FOUP (Front Opening Unified Pod) storing a plurality of semiconductor wafers and a container storing a glass substrate, a container such as a reticle pod, and common parts. In the following description, the overhead traveling vehicle 6 is simply referred to as a traveling vehicle 6. The rail-guided carrier system 1 includes the traveling track 4, a plurality of the traveling vehicles 6, a plurality of the placement sections 9, and a working track 41.

The traveling track 4 is laid, for example, in the vicinity of a ceiling that is a space above the worker's head. The traveling track 4 is, for example, suspended from the ceiling. The traveling track 4 is a predetermined traveling path for the traveling vehicles 6 to travel. The traveling track 4 is supported by struts 40A and 40A. The traveling track 4 of the rail-guided carrier system 1 includes a main-line section 4A for traveling in one direction around a predetermined area and an introduction section 4B for introducing each traveling vehicle 6 to the working track 41 provided with a working area 160 for maintenance of the traveling vehicle 6. Also, in the introduction section 4B, the traveling vehicle 6 moves in a predetermined one direction.

The traveling track 4 includes a tubular rail body 40 having a pair of lower surface portions 40B and 40B, a pair of side surface portions 40C and 40C, and a top surface portion 40D, and power feeders 40E. The rail body 40 accommodates (contains) a traveling unit 50 of the traveling vehicle 6. The lower surface portions 40B extend in a traveling direction of the traveling vehicle 6 and form a lower surface of the rail body 40. The lower surface portions 40B are plate-like members to allow traveling rollers 51 of the traveling vehicle 6 to roll and travel. The side surface portions 40C extend in the traveling direction of the traveling vehicle 6 and form side surfaces of the rail body 40. The top surface portion 40D extends in the traveling direction of the traveling vehicle 6 and forms an upper surface of the rail body 40. The top surface portion 40D includes a magnetic plate 40F.

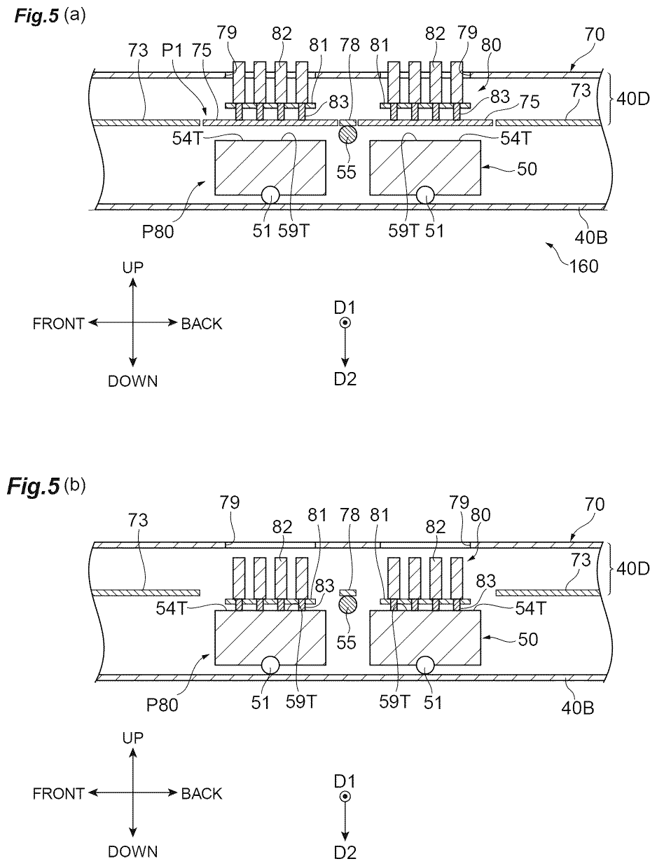

The power feeders (power feed lines) 40E each are a part configured to supply electricity to power supply cores 57 of the traveling vehicle 6 and to transmit and receive signals to and from the power supply cores 57. Each power feeder 40E is fixed to each of the pair of side surface portions 40C and 40C and extends along the traveling direction. The power feeders 40E supply electricity to the power supply cores 57 in a contactless state. The magnetic plate 40F causes LDMs (Linear DC motors) 59 of the traveling vehicle 6 to produce magnetic force for traveling or stopping. The magnetic plate 40F is fixed to a top plate 70 (see FIG. 5) of the top surface portion 40D with a not-illustrated bracket or the like, and extends along the traveling direction. The traveling vehicles 6 each are a rail-guided carrier driven by a linear motor.

Each traveling vehicle 6 travels along the traveling track 4 and transports the article 10. The wording “the traveling vehicle 6 travels on the traveling track 4” means that the traveling rollers 51 of the traveling vehicle 6 roll and travel on the lower surface portions 40B of the traveling track 4. The traveling vehicle 6 is configured to be able to transfer the article 10. The traveling vehicles 6 each are an automated overhead traveling vehicle. The number of the traveling vehicles 6 included in the rail-guided carrier system 1 is not particularly limited and is more than one. Each traveling vehicle 6 includes a main body 7, a traveling unit 50, and a control unit 35. The main body 7 includes a body frame 22, a lateral feed unit 24, a 0 drive 26, an elevation driver 28, an elevation stage 30, and covers 33.

The body frame 22 is connected to the traveling unit 50 and supports the lateral feed unit 24, the 0 drive 26, the elevation driver 28, the elevation stage 30, and the covers 33. The lateral feed unit 24 laterally feeds the 0 drive 26, the elevation driver 28, and the elevation stage 30 collectively in a right-angle direction with respect to the traveling direction of the traveling track 4. The 0 drive 26 turns at least one of the elevation driver 28 and the elevation stage 30 within a predetermined angle range in a horizontal plane. The elevation driver 28 elevates and lowers the elevation stage 30 by reeling or unreeling a suspension member such as a wire, a rope, and a belt. The elevation stage 30 is provided with a chuck and is able to grip or release the article 10. A pair of the covers 33 is provided, for example, on the front and the back of the traveling vehicle 6 in the traveling direction. The covers 33 extend and retract not-illustrated claws or the like and prevent the article 10 from dropping during transportation.

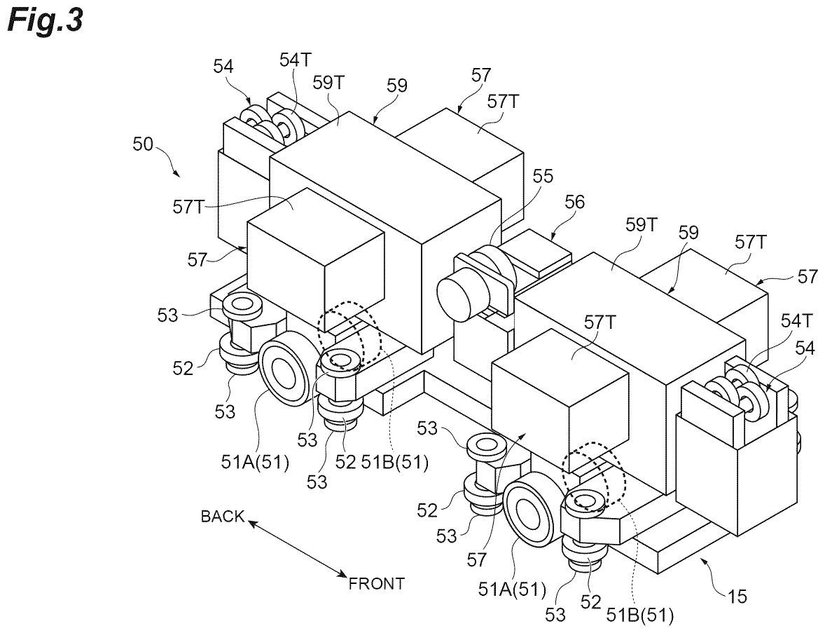

The traveling unit 50 causes the traveling vehicle 6 to travel along the traveling track 4. As illustrated in FIG. 3, the traveling unit 50 includes the traveling rollers 51, side rollers 52, branching rollers 53, auxiliary rollers 54, a touch roller 55, the power supply cores 57, and the LDMs 59. In FIG. 2, the branching rollers 53, the auxiliary rollers 54, and the touch roller 55 are not illustrated.

The traveling rollers 51 are roller pairs each including an outer wheel 51A as a traveling wheel and an inner wheel 51B as a traveling auxiliary wheel. The traveling rollers 51 are disposed on both of the left and right ends at the front and the back of the traveling unit 50. The traveling rollers 51 roll and travel on the pair of lower surface portions 40B and 40B of the traveling track 4. The side rollers 52 are disposed to sandwich each of the outer wheels 51A of the traveling rollers 51 in the front-back direction. The side rollers 52 are provided to be able to come into contact with the side surface portions 40C of the traveling track 4. The branching rollers 53 are disposed to sandwich each of the side rollers 52 in the up-down direction. The branching rollers 53 are provided to be able to come into contact with not-illustrated guides disposed at a connection section, a branching section, or the like of the traveling track 4.

The auxiliary rollers 54 are roller groups each including a set of three rollers that is provided at each of the front and the back of the traveling unit 50. The auxiliary rollers 54 are provided in order to prevent the LDMs 59, the power supply cores 57, and the like from coming into contact with the magnetic plate 40F disposed on an upper surface of the traveling track 4 when the traveling unit 50 is inclined to the front and the back during traveling, for example, due to acceleration or deceleration. The clearance between the auxiliary rollers 54 and the magnetic plate 40F is managed by a processing device 80 (to be described in detail later) to be a value in a desired range. Anti-tilt rollers are provided at four corners of each LDM 59 in order to prevent tilting due to centrifugal force that occurs when the traveling unit 50 travels a curve section, but the anti-tilt rollers are not illustrated in FIGS. 1 and 2.

The power supply cores 57 are disposed at the front and the back of the traveling unit 50 to sandwich each LDM 59 in the left-right direction. Power is fed in a contactless manner from each power feeder 40E disposed at the traveling track 4 and a variety of signals are transmitted and received in a contactless manner. The power supply cores 57 exchange signals with the control unit 35. The LDMs 59 are provided at the front and the back of the traveling unit 50. Each LDM 59 uses an electromagnet to produce magnetic force for traveling or stopping, between the LDM 59 and the magnetic plate 40F disposed on the upper surface of the traveling track 4. The clearance between each LDM 59 and the magnetic plate 40F is managed by the processing device 80 to be a value in a desired range.

As illustrated in FIG. 1, the placement sections 9 are arranged along the traveling track 4 and provided at positions where the article 10 can be delivered by the traveling vehicle 6. The placement sections 9 each include a buffer and a delivery port. The buffer is a placement section on which the article 10 is temporarily placed. The buffer is a placement section on which the article 10 is temporarily placed when the article 10 transported by the traveling vehicle 6 cannot be transferred to a target delivery port, for example, for the reason that another article 10 has been placed on the target delivery port. The delivery port is, for example, a placement section for delivering the article 10 to and from a semiconductor processing device (not illustrated) such as a cleaning device, a deposition device, a lithography device, an etching device, a thermal treatment device, and a planarization device. The processing device is not limited to a specific device and may be a variety of devices.

For example, the placement sections 9 are arranged to the side of the traveling track 4. Thus, the traveling vehicle 6 delivers the article 10 to and from each placement section 9 by causing the lateral feed unit 24 to laterally feed the elevation driver 28 or the like and by slightly elevating and lowering the elevation stage 30. Although not illustrated, the placement sections 9 may be arranged immediately below the traveling track 4. Thus, the traveling vehicle 6 transfers the article 10 to and from each placement section 9 by elevating and lowering the elevation stage 30.

The control unit 35 is an electronic control unit including a CPU (Central Processing Unit), a ROM (Read Only Memory), and a RAM (Random Access Memory). The control unit 35 controls various operations in the traveling vehicle 6. Specifically, the control unit 35 controls the traveling unit 50, the lateral feed unit 24, the 0 drive 26, the elevation driver 28, and the elevation stage 30. The control unit 35 can be configured, for example, as software that is a program stored in the ROM, loaded into the RAM, and executed by the CPU. The control unit 35 may be configured as hardware with electronic circuitry, for example. The control unit 35 communicates with a controller 90 using, for example, the power feeders 40E (feeder lines) of the traveling track 4.

The controller 90 is an electronic control unit including a CPU, a ROM, a RAM, and the like. The controller 90 can be configured, for example, as software that is a program stored in the ROM, loaded into the RAM, and executed by the CPU. The controller 90 may be configured as hardware with electronic circuitry, for example. The controller 90 transmits a transportation command to the traveling vehicle 6 to transport the article 10.

As illustrated in FIG. 1, the working area 160 is an area provided in a part of the introduction section 4B and in which maintenance of the traveling rollers 51, the LDMs 59, and the like of the traveling unit 50 included in the traveling vehicle 6 is performed. In the working area 160, the working track 41 and the processing device 80 are provided.

The working track 41 extends in one direction such that both ends thereof are continuous to the traveling track 4 and 4. The working track 41 is a part of the traveling track 4. In the rail-guided carrier system 1, the processing device 80 can perform work on the traveling vehicle 6 stopped at a working position P80 (see FIG. 5(a)) on the working track 41. That is, the working position P80 for maintenance (including inspection of each portion of the traveling track 4) is set in the working track 41.

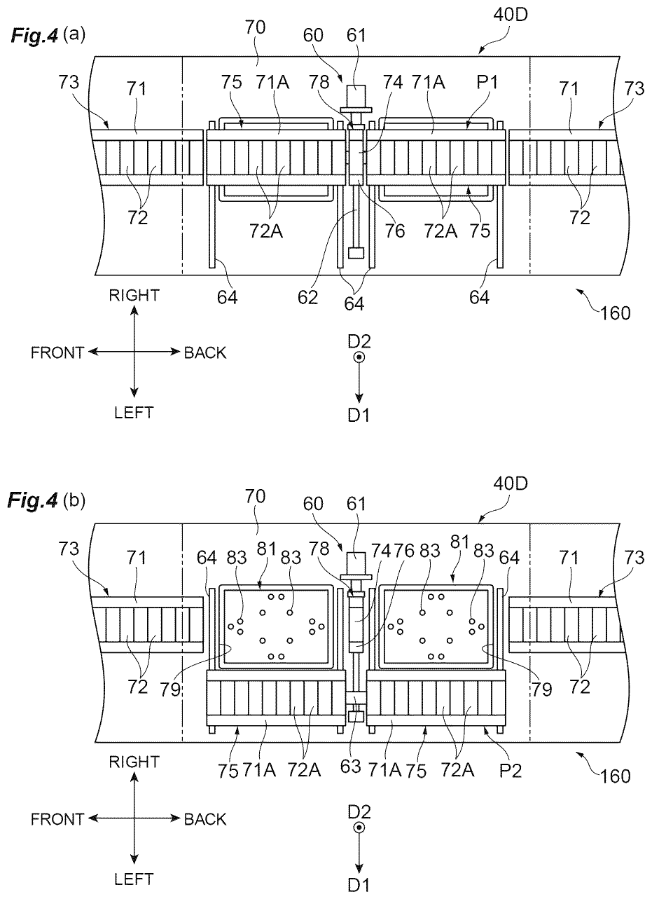

FIG. 4(a) is a view of the top surface portion 40D of the introduction section 4B (traveling track 4) at the working position P80 as viewed from below, and FIG. 5(a) is a side sectional view of the introduction section 4B and the traveling vehicle 6 in the state of FIG. 4(a). As illustrated in FIGS. 4(a) and 5(a), the rail-guided carrier system 1 includes the processing device 80 that performs the work on the traveling vehicle 6 on the working track 41 in the working area 160, and a retraction mechanism 60 that retracts, for the work on the traveling vehicle 6, a part of the top surface portion 40D being a part of the track. The content of the work by the processing device 80 is not particularly limited, and examples of the work include measurement of the height of each portion of the traveling vehicle 6 and photographing of an image of each portion of the traveling vehicle 6. In the following description, as an example, a mode in which the height (position) measurement of an upper portion of the traveling vehicle 6 is performed at the working position P80 will be described.

To begin with, a portion (work target portion) measured by the processing device 80 will be described with reference to FIG. 3. The processing device 80 comes into contact with upper ends 54T of the auxiliary rollers 54, upper surfaces 57T of the power supply cores 57, and upper surfaces 59T of the LDMs 59 from above the traveling vehicle 6 to measure the positions thereof. However, the measurement target portion (work target portion) is not limited to these portions. As illustrated in FIG. 5(a), the traveling unit 50 of the traveling vehicle 6 stopped at the working position P80 is disposed between the lower surface portion 40B as well as magnetic plates 73, movable magnetic plates 75, and a fixed magnetic plate 78, these plates being provided at the same height. The traveling rollers 51 are in contact with the upper surface of the top surface portion 40D, and the touch roller 55 is in contact with a lower surface of the fixed magnetic plate 78. In this state, the positions of the auxiliary rollers 54, the power supply cores 57, and the LDMs 59 in the traveling unit 50 are measured to diagnose the appropriateness of these positions. In FIG. 3, the detailed structures of each power supply core 57 and each LDM 59 are not illustrated, and the power supply cores 57 and the LDMs 59 are illustrated as simple blocks.

As illustrated in FIG. 5(a), the traveling unit 50 of the traveling vehicle 6 is self-propelled to the working area 160 according to a predetermined maintenance schedule, and stops at the working position P80. The touch roller 55 provided in the traveling unit 50 moves while being in contact with the magnetic plates 73, the movable magnetic plates 75, and the fixed magnetic plate 78 (all plates correspond to a plate-like portion) that form the magnetic plate 40F, with a predetermined pressure. The control unit 35 can recognize the position of the traveling vehicle 6 by the rotation of the touch roller 55 and by an encoder unit 56 (see FIG. 3) connected to the touch roller 55. The traveling vehicle 6 is able to be self-propelled on substantially the whole section of the traveling track 4 including the working track 41. That is, the power feeders 40E, the magnetic plate 40F, and the like are not omitted also in the working area 160, and the same configuration as the configuration of the main-line section 4A is provided in the whole section of the introduction section 4B.

The magnetic plate 40F includes the magnetic plates 73, the movable magnetic plates 75, and the fixed magnetic plate 78. The magnetic plates 73 are provided in the center of the top surface portion 40D in the width direction (left-right direction), and extend horizontally in the traveling direction of the traveling vehicle 6. As illustrated in FIG. 4(a), the magnetic plates 73 each include, for example, a base plate 71 fixed to the top plate 70 and installed horizontally, and a large number of magnet pieces 72 fixed to a lower surface of the base plate 71. The magnet pieces 72 are laid to be aligned in the traveling direction.

In a state in which the traveling vehicle 6 is stopped at the working position P80, a pair of the movable magnetic plates 75 and 75 located to sandwich the touch roller 55 in the traveling direction, and the fixed magnetic plate 78 with which the touch roller 55 is in contact are installed to be continuous with the magnetic plates 73. The movable magnetic plates 75 and 75 and the fixed magnetic plate 78 are provided in the center of the top surface portion 40D in the width direction (left-right direction), and are provided horizontally in the traveling direction of the traveling vehicle 6. Each movable magnetic plate 75 includes, for example, a base plate 71A fixed to the top plate 70 and installed horizontally, and a large number of magnet pieces 72A fixed to a lower surface of the base plate 71A. Similarly to the magnet pieces 72, the magnet pieces 72A are laid to be aligned in the traveling direction. The length of each movable magnetic plate 75 in the traveling direction is, for example, a length that covers the LDMs 59 and the auxiliary rollers 54 of the traveling vehicle 6 (longer than the length of the LDMs 59 and the auxiliary rollers 54) (see FIG. 5(a)).

The fixed magnetic plate 78 includes, for example, a base plate 76 fixed to the top plate 70 and installed horizontally, and one magnet piece 74 fixed to a lower surface of the base plate 76. The fixed magnetic plate 78 has, for example, a minimum size that allows the fixed magnetic plate 78 to support the touch roller 55 in the traveling direction. The fixed magnetic plate 78 may be provided with a plurality of the magnet pieces 74. The shape and size of one magnet piece 74 are desirably the same as those of each magnet piece 72 in each magnetic plate 73 and each magnet piece 72A in each movable magnetic plate 75.

As illustrated in FIG. 5(a), the top surface portion 40D includes the pair of movable magnetic plates 75 and one fixed magnetic plate 78 that extend in the traveling direction of the traveling vehicle 6. The traveling vehicle 6 includes, at the working position P80, the touch roller 55 for position recognition that comes into contact with the fixed magnetic plate 78. The touch roller 55 comes into contact with the magnetic plates 73 and the movable magnetic plates 75 in a self-propelled section until the traveling vehicle 6 reaches the working position P80.

As illustrated in FIGS. 4(a) and 5(a), the retraction mechanism 60 retracts, at the working position P80, only the pair of movable magnetic plates 75 (movable portions) not in contact with the touch roller 55, from among the pair of movable magnetic plates 75 that face the auxiliary rollers 54, the power supply cores 57, and the LDMs 59 that form the upper portion of the traveling vehicle 6, and the fixed magnetic plate 78. That is, the retraction mechanism 60 retracts only the movable portions other than the fixed magnetic plate 78 that is a specific portion with which the touch roller 55 is in contact, from among the pair of movable magnetic plates 75 and the fixed magnetic plate 78. The pair of movable magnetic plates 75 is adjacent to the front and the back of the fixed magnetic plate 78 in the traveling direction, and is moved laterally (in a first moving direction D1) by the retraction mechanism 60. At this time, only the fixed magnetic plate 78 remains in the center of the top surface portion 40D in the width direction (the position of the fixed magnetic plate 78 is maintained).

Describing a configuration example of the retraction mechanism 60 with reference to FIGS. 4(a) and 4(b), the retraction mechanism 60 includes a drive motor 61 and a screw shaft 62 that are fixed to the top plate 70 of the top surface portion 40D, and a movable nut 63 that is fitted to the screw shaft 62 and moves according to the rotation of the screw shaft 62. The drive motor 61, the screw shaft 62, and the movable nut 63 constitute a ball screw mechanism. A pair of the base plates 71A (movable magnetic plates 75) is fixed to both of the front and the back ends of the elevation stage 30. The pair of base plates 71A is able to move in the left-right direction along four guides 64 fixed to the top plate 70. The screw shaft 62 and the movable nut 63 overlap the fixed magnetic plate 78 when viewed from below, but are arranged, for example, above the fixed magnetic plate 78 not to spatially interfere with the fixed magnetic plate 78.

The retraction mechanism 60 slides and moves the pair of movable magnetic plates 75 horizontally from a normal position P1 at which the movable magnetic plates 75 and the magnetic plate 73 are continuous in a straight line, to a retracted position P2 at which measurement by the processing device 80 is permitted. For example, rectangular openings 29 are formed at the top plate 70 of the top surface portion 40D, and, for example, the processing device 80 is disposed in the openings 29. The processing device 80 is installed above the top plate 70 before the work, and may pass the openings 29 while being lowered during the work process. The drive motor 61, the screw shaft 62, and the guides 64 of the retraction mechanism 60 are provided outside virtual spaces defined by the openings 29 and shaped as quadrangular prisms that extend in the up-down direction, and do not interfere with the measurement work by the processing device 80.

As illustrated in FIG. 4(b), attachment plates 81 of the processing device 80 and a plurality of sensor contacts 83 attached to the attachment plates 81 are exposed in the openings 29 by the retraction mechanism 60 sliding and moving the pair of movable magnetic plates 75. This means that the work target portion of the traveling vehicle 6 is exposed at the normal position P1 (openings 29) of the pair of movable magnetic plates 75 when viewed from above, which is opposite to FIG. 4(b).

The processing device 80 includes the attachment plates 81, a not-illustrated elevation motor that elevates and lowers the attachment plates 81, and a plurality of cylinders 82 and the sensor contacts 83 attached to each attachment plate 81. After the pair of movable magnetic plates 75 is retracted (moved) by the retraction mechanism 60, the attachment plates 81, the cylinders 82, and the sensor contacts 83 are lowered as illustrated in FIG. 5(b). When the sensor contacts 83 come into contact with the upper portion of the traveling vehicle 6 as the attachment plates 81 are lowered, the sensor contacts 83 retract into the cylinders 82. The processing device 80 can measure the positions of the upper ends 54T of the auxiliary rollers 54, the upper surfaces 57T of the power supply cores 57, and the upper surfaces 59T of the LDMs 59 in the traveling vehicle 6 based on amounts of movement of the sensor contacts 83 at the time when the attachment plates 81 stop at predetermined positions. After the measurement by the processing device 80 is completed, the attachment plates 81 are elevated by the processing device 80 in the reverse procedure, and then, the pair of movable magnetic plates 75 is made back to the normal position P1. The pair of movable magnetic plates 75 is made back to the normal position P1, whereby the traveling vehicle 6 is able to be self-propelled and return to the normal operation.

The first moving direction D1 of the pair of movable magnetic plates 75 retracted by the retraction mechanism 60 is a horizontal direction, and a second moving direction D2 in which the sensor contacts 83 (working portions) of the retraction mechanism 60 move toward the traveling vehicle 6 for the measurement is the up-down direction (vertical direction). Hence, the first moving direction D1 and the second moving direction D2 are orthogonal to each other.

In the rail-guided carrier system 1, a part of the working track 41 is retracted by the retraction mechanism 60. Thus, similarly to the traveling track 4, the introduction section 4B for the working position P80 can also include a configuration necessary for the traveling of the traveling vehicle 6. For example, unlike the above WO 2020/202856, a configuration in which the power feeders 40E are included in the introduction section 4B is also possible. Thus, the traveling vehicle 6 can be self-propelled to the working position P80. After the part of the track is retracted by the retraction mechanism 60, the work is performed, by the processing device 80, on the work target portion of the traveling vehicle 6 stopped at the working position P80. Hence, the work is allowed only by causing the traveling vehicle 6 to be self-propelled to the working position P80 and causing the part of the track to move to the retracted position P2 while the traveling vehicle 6 is stopped at the working position P80, and the work on the traveling vehicle 6 can be easily performed. Furthermore, space saving is achieved.

For example, in the system described in the above WO 2020/202856, measurement by sensors and photographing of an image by a camera are performed after the carrier is moved to the opening with its upper surface opened by an external mechanism. Thus, an operation by the external mechanism chucking the carrier, and a preliminary operation by the carrier inserting a towed member into a towing member and the like are required, and the sequence may be complicated. With the rail-guided carrier system 1, the preliminary operation is unnecessary and the sequence is also simplified.

The retraction mechanism 60 retracts at least the part of the top surface portion 40D, and the processing device 80 comes into contact with the upper portion of the traveling vehicle 6 from above to measure the position of the upper portion. This enables automation of the position measurement of the upper portion of the traveling vehicle 6. The processing device 80 may photograph the upper portion of the traveling vehicle 6. This enables automation of the photographing of an image of the upper portion of the traveling vehicle 6 and the like.

In retracting the movable magnetic plates 75, the fixed magnetic plate 78 with which the touch roller 55 is in contact does not move, and the contact state with the touch roller 55 is maintained. Thus, a state in which the traveling vehicle 6 can recognize its own position is maintained, and the return-to-operation after the work can be smoothly performed. This leads to a reduction in cycle time. The return-to-operation after the work can also be performed automatically. In addition, since the movable magnetic plates 75 that move are not in contact with the touch roller 55, the movable magnetic plates 75 do not rub against the touch roller by the retraction, and wear of the touch roller 55 is inhibited. In the system described in the above WO 2020/202856, since the work is performed at the opening, the touch roller 55 is detached from the surface of the magnetic plate to be allowed to freely rotate. Thus, the carrier itself is in an unfixed positional state during the operation by the external mechanism, so that it is necessary to perform home positioning again at the time of re-entry. With the rail-guided carrier system 1, reduction in cycle time is possible as described above.

Since the specific portion is the fixed magnetic plate 78 and the movable portions are the movable magnetic plates 75, the work can be easily performed in the traveling vehicle 6 driven by the linear motor. Only the movable magnetic plates 75 may be retracted by the retraction mechanism 60 and after the work, only the movable magnetic plates 75 may be made back to the normal position P1. Thus, the return-to-operation after the work can be smoothly performed.

Access to the upper portion of the traveling vehicle 6 is allowed at the portion of the normal position P1 at which the movable magnetic plates 75 are originally located, by the movable magnetic plates 75 sliding and moving. Thus, the processing device 80 can be disposed easily in an area that does not hinder the travel of the traveling vehicle 6 (outside the traveling locus of the traveling unit 50), and the work can be performed more quickly.

The first moving direction D1 of the pair of movable magnetic plates 75 retracted by the retraction mechanism 60 is orthogonal to the second moving direction D2 in which the sensor contacts 83 (working portions) of the retraction mechanism 60 move toward the traveling vehicle 6 for the measurement. This facilitates smooth exposure of the upper portion of the traveling vehicle 6. The access to the upper portion of the traveling vehicle 6 by the sensor contacts 83 of the processing device 80 is easy.

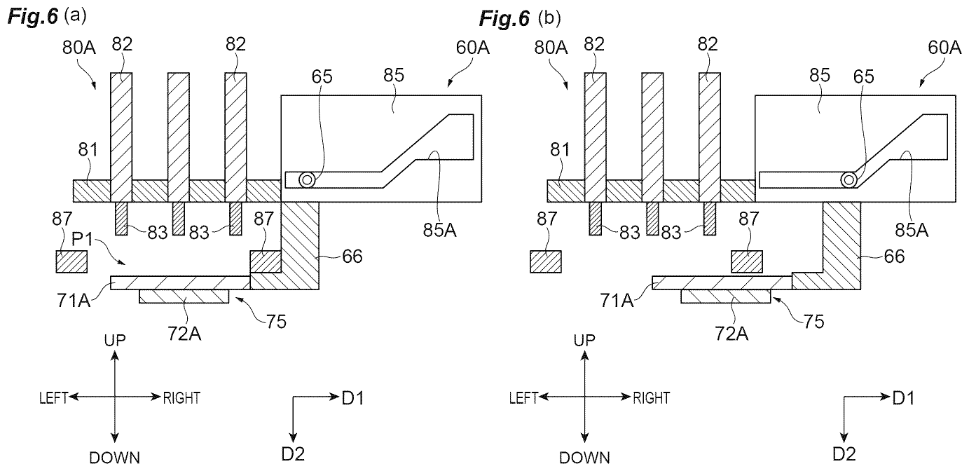

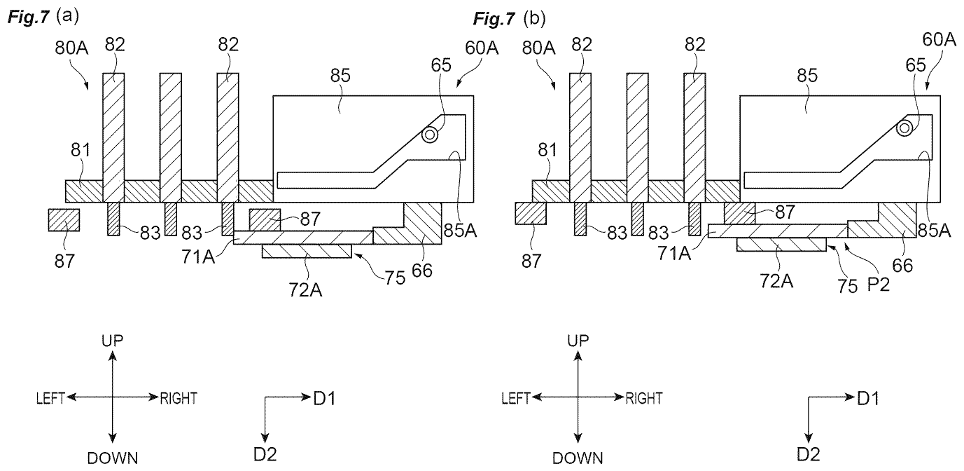

Although an embodiment has been described above, this disclosure is not limited to the above-described embodiment. For example, as in a modification illustrated in FIGS. 6(a) to 7(b), an attachment plate 81 of a processing device 80A may be moved up and down by a cam mechanism in response to movement of a movable magnetic plate 75. FIGS. 6(a), 6(b), 7(a), and 7(b) are side sectional views each illustrating movement of portions in the modification of simultaneous driving type in which a retraction mechanism being a part of a track and a moving mechanism for work are combined. As illustrated in FIG. 6(a), the processing device 80A includes a cam 85 fixed to the attachment plate 81 in addition to the attachment plate 81, cylinders 82, and sensor contacts 83. A guide hole 85a is formed in the cam 85. A retraction mechanism 60A includes the movable magnetic plate 75 and a pin 65 disposed in the guide hole 85a, and the movable magnetic plate 75 and the pin 65 are coupled to each other via a coupling portion 66. The attachment plate 81 is biased downward by biasing means or under its own weight. As illustrated in FIG. 6(b), when the movable magnetic plate 75 is moved laterally (by a not-illustrated drive motor or the like), the pin 65 moves in the guide hole 85a, and the attachment plate 81 starts to be lowered.

Next, as illustrated in FIG. 7(a), when the movable magnetic plate 75 is moved further laterally, the pin 65 moves in the guide hole 85a, and the attachment plate 81 is further lowered. Then, as illustrated in FIG. 7(b), at the time when the movable magnetic plate 75 completes retraction and is located at a retracted position P2, the attachment plate 81 is supported by a stopper 87 to stop, and the sensor contacts 83 come into contact with a work target portion of a traveling vehicle 6. This simultaneous movement of the retraction mechanism 60A and the processing device 80A reduces the number of motors to enable cost reduction, which also enables simplification of the control sequence.

The work target portion of the rail-guided carrier is not limited to the upper portion, and may be a side portion (left- or right-side portion or both of the left- and right-side portions), a lower portion, a lower surface, or the like. A plurality of these portions may be combined as the work target portion. As the processing device, a non-contact sensor that measures the position of the work target portion in a non-contact manner may be applied. The processing device is not limited to performing the measurement or photographing of the traveling vehicle 6 (rail-guided carrier), and a device that performs other processing on the traveling vehicle 6 may be applied. The work target portion may be set to any portion of the traveling vehicle 6.

This disclosure is not limited to the aspect of the above embodiment (retraction of the movable magnetic plates), and the “part of the track” facing the work target portion, in addition to the movable magnetic plates, may be retracted. As long as the “part of the track” is any other wall portion different from the wall portion (a part of side walls or a part of an upper wall) necessary for self-propelling, such a portion can be employed as the “part of the track” to be retracted. For example, only a specific portion of the side walls (side surface portions 40C) in contact with the side rollers of the carrier at the working position may be set as a fixed portion, and a portion other than the specific portion of the side walls may be set as a movable portion. This disclosure is not limited to the rail-guided carrier driven by the linear motor, and may be applied to a self-propelled rail-guided carrier in which driving rollers are in contact with the upper wall (top surface portion 40D). Thus, only a specific portion of the upper wall with which the driving rollers of the carrier are in contact at the working position may be set as a fixed portion, and a portion other than the specific portion of the upper wall may be set as a movable portion.

In any modification, the direction of movement (retraction) of the movable portion of the side walls and/or of the movable portion of the upper wall may, for example, be a direction perpendicular to the normal of the wall portion concerned (i.e., a planar movement along the wall portion), and, in this instance, the movable portion may slide and move linearly, or may be pivoted around the normal and slide arcuately. The movable portion may be moved in a direction perpendicular to the normal of the wall portion. The moving direction of the working portions such as the sensor contacts 83 may be other than the second moving direction D2.

When a part of the side walls is the movable portion, a part (a component such as a cable) related to power supply may be installed with a margin in length or the like to follow a movable range as necessary.

In the above embodiment, the example in which this disclosure is applied to the traveling track 4 for suspending and traveling the traveling vehicles 6 has been described, but this disclosure can also be applied to a rail-guided carrier system in which a traveling vehicle travels on a track disposed on the ground.

The constituent elements may be described as follows.

[1] A rail-guided carrier system in which a working position at which a processing device performs work on a rail-guided carrier stopped on a track is set, the rail-guided carrier system including
a retraction mechanism configured to retract a part of the track facing a work target portion of the rail-guided carrier at the working position.
   [2] The rail-guided carrier system according to [1], in which
the retraction mechanism retracts at least a part of a top surface portion of the track, and
the processing device is in contact with an upper portion of the rail-guided carrier from above to measure a position of the upper portion, or photographs the upper portion of the rail-guided carrier.
   [3] The rail-guided carrier system according to [2], in which
the top surface portion of the track includes a plate-like portion extending in a traveling direction of the rail-guided carrier,
the rail-guided carrier includes a touch roller for position recognition that comes in contact with the plate-like portion of the track, and
the retraction mechanism retracts only a movable portion other than a specific portion with which the touch roller is in contact at the working position, of the plate-like portion facing the upper portion of the rail-guided carrier.
   [4] The rail-guided carrier system according to [3], in which
the plate-like portion is magnetic plates, and
the specific portion is a fixed magnetic plate with which the touch roller is in contact at the working position, and the movable portion is movable magnetic plates adjacent to a front and a back of the fixed magnetic plate in the traveling direction.
   [5] The rail-guided carrier system according to any one of [1] to [4], in which the work target portion is exposed by the retraction mechanism sliding and moving the part of the track from a normal position to a retracted position.
   [6] The rail-guided carrier system according to any one of [1] to [5], in which a first moving direction of the part of the track retracted by the retraction mechanism is orthogonal to a second moving direction in which a working portion of the processing device moves toward the rail-guided carrier for the work.

1. A rail-guided carrier system in which a working position at which a processing device performs work on a rail-guided carrier stopped on a track is set, the rail-guided carrier system comprising
a retraction mechanism configured to retract a part of the track facing a work target portion of the rail-guided carrier at the working position.

2. The rail-guided carrier system according to claim 1, wherein
the retraction mechanism retracts at least a part of a top surface portion of the track, and
the processing device is in contact with an upper portion of the rail-guided carrier from above to measure a position of the upper portion, or photographs the upper portion of the rail-guided carrier.

3. The rail-guided carrier system according to claim 2, wherein
the top surface portion of the track includes a plate-like portion extending in a traveling direction of the rail-guided carrier,
the rail-guided carrier includes a touch roller for position recognition that comes in contact with the plate-like portion of the track, and
the retraction mechanism retracts only a movable portion other than a specific portion with which the touch roller is in contact at the working position, of the plate-like portion facing the upper portion of the rail-guided carrier.

4. The rail-guided carrier system according to claim 3, wherein
the plate-like portion is magnetic plates, and
the specific portion is a fixed magnetic plate with which the touch roller is in contact at the working position, and the movable portion is movable magnetic plates adjacent to a front and a back of the fixed magnetic plate in the traveling direction.

5. The rail-guided carrier system according to claim 1, wherein the work target portion is exposed by the retraction mechanism sliding and moving the part of the track from a normal position to a retracted position.

6. The rail-guided carrier system according to claim 1, wherein a first moving direction of the part of the track retracted by the retraction mechanism is orthogonal to a second moving direction in which a working portion of the processing device moves toward the rail-guided carrier for the work.
